(19) United States
(12) Patent Application Publication
(10) Pub. No.: US 2024/0014858 A1
(43) Pub. Date: Jan. 11, 2024

(54) SCHEDULING FOR MULTI-TRANSMISSION RECEPTION POINT TRANSMISSION WITH DYNAMIC ON-OFF SWITCHING

(71) Applicant: Telefonaktiebolaget LM Ericsson (publ), Stockholm (SE)

(72) Inventors: Gunther AUER, Göteborg (SE); Ahsan MAHMOOD, Sundbyberg (SE); Miguel BERG, Sollentuna (SE); Chenguang LU, Sollentuna (SE)

(73) Assignee: Telefonaktiebolaget LM Ericsson (publ), Stockholm (SE)

(21) Appl. No.: 17/778,894

(22) PCT Filed: Dec. 1, 2020
(86) PCT No.: PCT/IB2020/061325

§ 371 Date: May 23, 2022

Related U.S. Application Data
(60) Provisional application No. 62/942,185, filed on Dec. 1, 2019.

(51) Int. Cl. H04B 7/024; H04L 5/00

(52) U.S. Cl. CPC H04B 7/024; H04L 5/0058

(57) ABSTRACT

A method by a wireless device includes transmitting at least one radio channel measurement associated with one of a plurality of transmitting and receiving point (TRPs). The wireless device receives information indicating a selection of a first subset of TRPs for use in receiving one or more signals from at least one TRP and/or transmitting one or more signals to at least one TRP. The selection of the first subset of TRPs is based at least in part on the radio channel measurement, and the first subset of the TRPs is less than all of the plurality of TRPs.

### TECHNICAL FIELD

The present disclosure relates, in general, to wireless communications and, more particularly, systems and methods for scheduling for transmission of multiple transmission and receiving points (TRP) with dynamic on-off switching.

### BACKGROUND

Cells with multiple distributed transmission and receiving points (TRP) have been used to cover signal dead spots and/or to increase the system capacity. They are useful in indoor environments with complex floor plans, including inner walls and elevator shafts, which will cause many signal dead spots (or coverage holes). However, in open scenarios with no walls (such as industrial environments), having multiple TRPs may increase downlink and uplink interference between cells.

This disclosure is focused on small cells with multiple TRPs. For simplicity, it is assumed herein that the antennas used for transmitting are also used as receiving antennas, such that one node contains both a transmitter and a receiver. However, it is generally recognized that transmission and receiving points may not necessarily be collocated. Thus, embodiments described herein may include a node containing a transmitter, a receiver, or both.

According to certain embodiments, implementation constraints (hardware, software, and/or fronthaul network) may be such that at most one signal stream is transmitted to a number of TRPs of the small cell in the downlink, and the same TRPs receive the signal transmitted by user equipments (UEs) within their coverage area in the uplink. These constraints, if imposed by the implementation, is a tradeoff between complexity and performance, since a very simple distribution and combining network can be used in a central processing unit, termed hub. One cell is composed of N nodes, and one hub may serve up to N_{cell} cells. FIG. 1 illustrates an example of one such small cell. More specifically, FIG. 1 illustrates a structure of distributed small cells with pooled baseband. In the illustrated example, the small cell includes four nodes, and each node contains one TRP. Thus, each node ni, i=1, . . . , 4 contains a TRP. The received signals are combined in the hub.

FIG. 2 illustrates an example Radio Dot System (RDS) based on a similar architecture, where nodes are called Radio Dots and the combining of the signals is performed in the indoor radio unit (IRU).

FIG. 3 illustrates a Distributed Antenna System (DAS) having a similar architecture.

For wireless communications, any signal transmitted from one wireless device (i.e., UE) will arrive at different TRPs with different distortions in phase and amplitude due to multipath fading. Additionally, the received signal at each TRP will consist of the distorted desired signal, interference from other transmitting UEs plus thermal noise.

The RDS, as illustrated in FIG. 2, is a special case of the general architecture illustrated in FIG. 1. For example, FIG. 2 shows the major building blocks of the RDS, where cell 1 consists of 4 Radio Dots (nodes), each Radio Dot includes one TRP, local area network (LAN) cables, indoor radio unit (IRU) 1, common public radio interface (CPRI) 1, baseband (BB) processing unit 1, and backhaul 1. In FIG. 1, the hub is comprised of IRU 1, CPRI 1 and BB 1. Note that the hub is a logical entity here and that the IRU and BB do not have to be co-located.

One BB is capable of supporting multiple IRUs. For the example in FIG. 2, BB 1 is supporting 2 IRUs. For cell 1, 6 Radio Dots connected to IRU 1 and 2 are serving the indoor area marked with blue and red, respectively. Unless otherwise stated, all Radio Dots connected to an IRU comprise one cell. However, the embodiments described herein are also applicable to cases where one IRU constitutes multiple cells, or where several IRUs are grouped together to form one cell, as well as combinations thereof.

The signal transmitted from one UE will be received by all TRPs within its coverage range, and the received signals of TRPs will be sent through LAN cables to IRU 1 for further processing. Inside IRU 1, the received signals will be non-coherently combined, and the resulting digital samples will be sent through CPRI 1 to BB 1 for baseband processing. Analog-to-digital conversion can be performed either in the IRU (before or after combining), or in each Radio Dot. Inside BB, the received digital samples will be processed by Discrete Fourier Transform (DFT), Inverse DFT (IDFT), channel estimation, demodulation, decoding, etc.

The resulting user data from BB will be transmitted through a backhaul connection, such as backhaul 1, to core network. Due to hardware cost, the number of CPRI links available between one IRU and BB may be limited. As a result, the bandwidth, in terms of bits per second, between one IRU and BB may also be limited. Therefore, inside IRU, the received signals from different TRPs cannot be individually processed (filtered, carrier de-multiplexing etc.) and sent through CPRI to BB; instead, the received signals are combined by the IRU to reduce the number of antenna carriers to be sent through CPRI.

FIG. 4 illustrates a Multi-TRP system where all TRPs are simultaneously active. There are different possibilities to combine the uplink signals of TRPs that belong to one cell. In this disclosure, non-coherent combining of the N signal streams is assumed. For example, the signal streams from the N TRPs may just be added without correcting the phase of the received signal. Non-coherent combining is of low complexity, as it mitigates the need for channel estimation of the individual signal streams. However, non-coherent combining increases both noise and interference. For the former, thermal noise is increased by a factor of N, and for the latter the interference may rise since more TRPs collect signals from ongoing transmissions in neighboring cells.

In the downlink, in previous systems and techniques, including the RDS or DAS, the N transmitted signals are simultaneously transmitted by all TRPs that belong to the same cell. The N TRPs constitute a single frequency network. While this allows for simple implementation and small variation in received signal strength, including passive distribution of the transmitted signal streams, the transmitted signal is conveyed in areas which are far apart from the desired user and may, therefore, spread unnecessary interference to neighboring cells, thus potentially degrading system performance.

Certain problems exist. For example, as discussed above, one problem with the existing solution is that the non-coherently summed signal contains uplink from all TRPs, including those TRPs with very poor Signal to Interference Plus Noise Ratio (SINR) of the received signal. This may be due to a strong interfering transmitter source close to that TRP. It is, thus, a problem that TRP with low SINR degrades the effective SINR after combining significantly. Likewise, on the transmit side, a TRP with diminishing contribution to the desired user's received signal degrades the average received SINR of UEs in neighboring cells, as shown in FIG. 4. Moreover, as all TRPs are always active, the energy consumption may be unnecessarily high.

### SUMMARY

Certain aspects of the present disclosure and their embodiments may provide solutions to these or other challenges. For example, a sophisticated means of distributing a signal between baseband and a number of TRPs is described. According to certain embodiments, for example, instead of all the TRPs associated to one cell always actively transmitting/receiving simultaneously identical signals, a dynamic selection of a set of active TRPs that have the strongest signal towards the desired user(s) is proposed. The remaining TRPs belonging to the same cell may be muted. This may give rise to an improved SINR at the receiver.

According to certain embodiments, a method by a wireless device includes transmitting, to a network node, at least one radio channel measurement. The at least one radio channel measurement is associated with an associated one of a plurality of TRPs, and the plurality of TRPs are associated with a single cell. The wireless device receives, from the network node, information indicating a selection of a first subset of the plurality of TRPs, for use in at least one of receiving one or more signals from at least one TRP within the first subset of the plurality of TRPs and/or transmitting one or more signals to at least one TRP within the first subset of the plurality of TRPs. The selection of the first subset of the plurality of TRPs is based at least in part on the at least one radio channel measurement, and the first subset of the TRPs is less than all of the plurality of TRPs.

According to certain embodiments, a wireless device includes processing circuitry configured to transmit, to a network node, at least one radio channel measurement. The at least one radio channel measurement is associated with an associated one of a plurality of TRPs, and the plurality of TRPs are associated with a single cell. The processing circuitry is configured to receive, from the network node, information indicating a selection of a first subset of the plurality of TRPs, for use in at least one of receiving one or more signals from at least one TRP within the first subset of the plurality of TRPs and/or transmitting one or more signals to at least one TRP within the first subset of the plurality of TRPs. The selection of the first subset of the plurality of TRPs is based at least in part on the at least one radio channel measurement, and the first subset of the TRPs is less than all of the plurality of TRPs.

According to certain embodiments, a method by a network node includes obtaining a plurality of radio channel measurements. Each of the plurality of radio channel measurements is associated with an associated one of a plurality of TRPs, and the plurality of TRPs associated with a single cell. Based on the plurality of radio channel measurements, the network node selects a first subset of the TRPs for use in at least one of transmitting of one or more signals to one or more wireless devices and/or receiving one or more signals from one or more wireless devices. The first subset of the TRPs is less than all of the plurality of TRPs.

According to certain embodiments, a network node includes processing circuitry configured to obtain a plurality of radio channel measurements. Each of the plurality of radio channel measurements is associated with an associated one of a plurality of TRPs, and the plurality of TRPs associated with a single cell. Based on the plurality of radio channel measurements, the processing circuitry is configured to select a first subset of the TRPs for use in at least one of transmitting of one or more signals to one or more wireless devices and/or receiving one or more signals from one or more wireless devices. The first subset of the TRPs is less than all of the plurality of TRPs.

Certain embodiments may provide one or more of the following technical advantages. For example, one technical advantage may be that, compared to passive DAS or other previous multi-TRP systems, certain embodiments include dynamically on-off switching (DOOS) of TRPs. The DOOS may have any one or more of the following advantages:
Reduced interference: due to the, on average, increased distance between closest interferer and victim receiver, the received interference from aggressor transmitters is reduced.
Reduced interference translates to improved SINR, which in turn will be observed as improved user experience and system performance.
Increasing the distance between closest interferer and victim receiver is particularly relevant for venues characterized by large open spaces and/or high ceilings. In such environments, the distance between interferer and victim receiver is crucial to improve the SINR.
Avoiding waste of unused resources when serving users with short packets.
Uplink noise figure (NF) is improved since the non-coherent combining is no longer needed (or at least fewer UL signals need to be combined). This may allow lower uplink power control target (P0 setting), which in turn could lead to UE power saving.
TRP power consumption can be reduced significantly if proper parts of the signal chain (UL and/or DL) are disabled when not needed.
Performance gains are applicable to both downlink and uplink.

As another example, a technical advantage may be that certain embodiments allow for an efficient implementation of DOOS into existing hardware, such as the RDS, by utilizing the beam management framework [3] that is an integral part of the 5^{th} Generation (5G) New Radio (NR) standard. Beam management was included in the 5G NR standard to handle Active Antenna Systems (AASs), especially at millimeter-wave frequencies.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a small cell;

FIG. 2 illustrates an example Radio Dot System (RDS);

FIG. 3 illustrates a Distributed Antenna System (DAS);

FIG. 4 illustrates a system of multiple transmission and receiving points (TRPs) where all TRPs are simultaneously active;

FIG. 5 illustrates an example embodiment that utilizes dynamic on-off switching (DOOS), according to certain embodiments;

FIG. 6 illustrates the switching apparatus within the indoor radio unit (IRU), according to certain embodiments;

FIG. 7 illustrates a simple example with 2 TRPs, according to certain embodiments;

FIGS. 8A and 8B illustrates example systems with multiple simultaneously active TRPs per cell, according to certain embodiments;

FIG. 9 illustrates an example DOOS scenario, according to certain embodiments;

FIGS. 10A and 10B illustrate a comparison for an example DOOS scenario for multi-TRP scheduling, according to certain embodiments;

FIGS. 11A and 11B illustrate downlink multi-TRP management, according to certain embodiments;

FIGS. 12A and 12B illustrate uplink multi-TRP management, according to certain embodiments;

FIG. 13 illustrates an example wireless network, according to certain embodiments;

FIG. 14 illustrates an example network node, according to certain embodiments;

FIG. 15 illustrates an example wireless device, according to certain embodiments;

FIG. 16 illustrate an example user equipment, according to certain embodiments;

FIG. 17 illustrates a virtualization environment in which functions implemented by some embodiments may be virtualized, according to certain embodiments;

FIG. 18 illustrates a telecommunication network connected via an intermediate network to a host computer, according to certain embodiments;

FIG. 19 illustrates a generalized block diagram of a host computer communicating via a base station with a user equipment over a partially wireless connection, according to certain embodiments;

FIG. 20 illustrates a method implemented in a communication system, according to one embodiment;

FIG. 21 illustrates another method implemented in a communication system, according to one embodiment;

FIG. 22 illustrates another method implemented in a communication system, according to one embodiment;

FIG. 23 illustrates another method implemented in a communication system, according to one embodiment;

FIG. 24 illustrates an example method by a wireless device, according to certain embodiments;

FIG. 25 illustrates an example virtual apparatus, according to certain embodiments;

FIG. 26 illustrates another example method by a wireless device, according to certain embodiments;

FIG. 27 illustrates another example virtual apparatus, according to certain embodiments;

FIG. 28 illustrates an example method by a network node, according to certain embodiments;

FIG. 29 illustrates another example virtual apparatus, according to certain embodiments;

FIG. 30 illustrates an example method by a network node, according to certain embodiments; and

FIG. 31 illustrates another example virtual apparatus, according to certain embodiments.

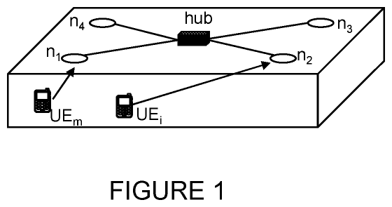

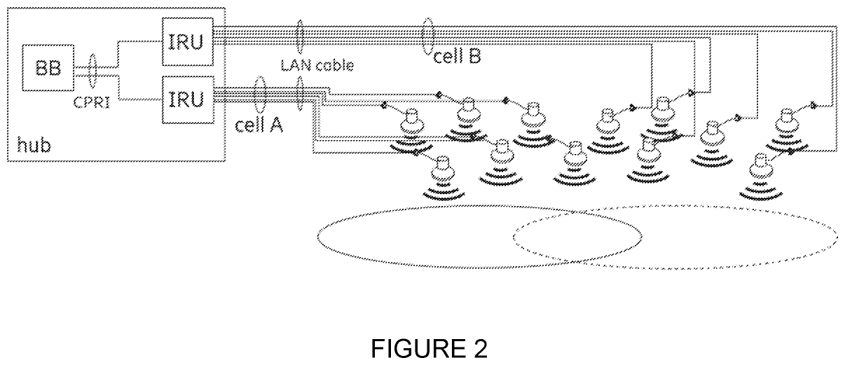

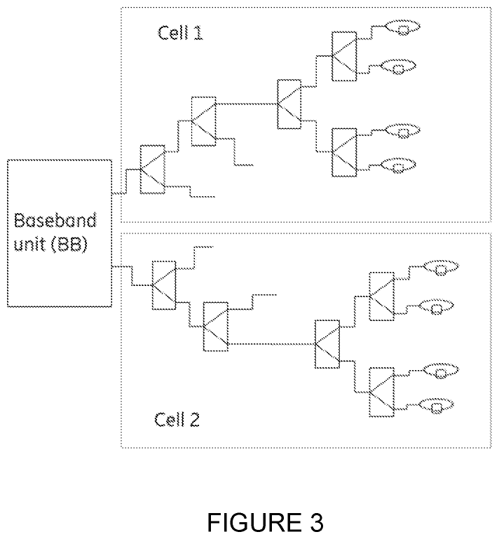

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNB (MeNB), ENB, a network node belonging to master cell group (MCG) or secondary cell group (SCG), base station (BS), multi-standard radio (MSR) radio node such as MSR base station (BS), eNodeB, gNodeB, network controller, radio network controller (RNC), base station controller (BSC), relay, donor node controlling relay, base transceiver station (BTS), access point (AP), transmission points, transmission nodes, remote radio unit (RRU), remote radio head (RRH), nodes in distributed antenna system (DAS), core network node (e.g. Mobile Switching Center (MSC), Mobility Management Entity (MME), etc.), Operation & Maintenance (O&M), Operations Support System (OSS), Self-Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc. It is noted that the terms user equipment and wireless device are used interchangeably herein.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems for distributing a signal between baseband and a number of TRPs (with the previously described implementation constraints) is provided. Instead of all the TRPs associated to one cell always actively transmitting/receiving simultaneously identical signals, methods and systems proposed herein include dynamic selection of a set of active TRPs that have the strongest signal towards the desired user(s), while muting the remaining TRPs belonging to the same cell. This gives rise to an improved SINR at the receiver.

Certain embodiments and techniques described herein may be implemented within the previously described implementation constraints.

According to certain embodiments, instead of all the TRPs associated to one cell always actively transmitting/receiving simultaneously identical signals, a dynamic selection of a set of active TRPs that have the strongest signal towards the desired user(s) is proposed. The remaining TRPs belonging to the same cell may be muted. This may give rise to an improved SINR at the receiver.

According to certain embodiments, methods and systems for activating and/or muting individual TRPs in a multi-TRP system are provided. The methods and systems may be implemented within the constraints disclosed above. Certain particular embodiments may:
enable efficient multi-user scheduling that gives the scheduler sufficient degrees of freedom to first, serve several UEs in one TTI; and second, have as many as possible TRPs muted.
apply the AAS framework for 5G NR to carry out the necessary measurements in an efficient manner, and the ability to reuse existing baseband implementation intended for AAS products.

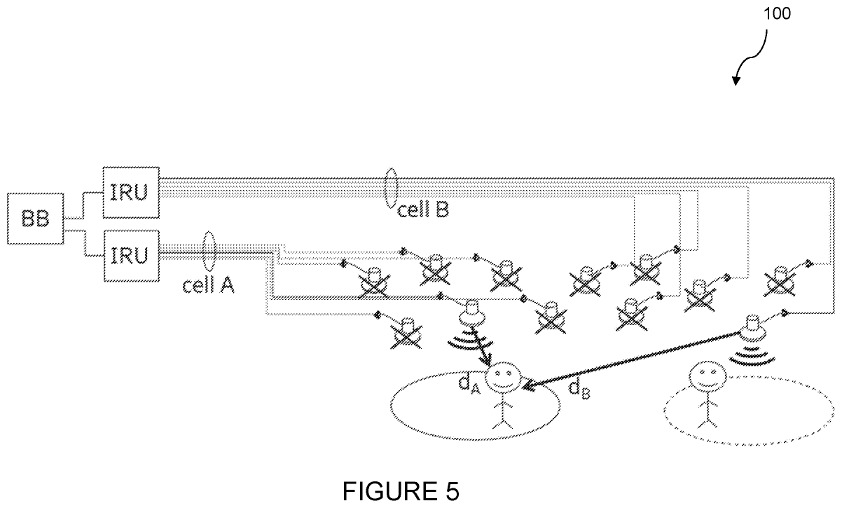

FIG. 5 illustrates an example embodiment of a multi-TRP system 100 that utilizes dynamic on-off switching (DOOS), according to certain embodiments. For example, in the illustrated example embodiment, one TRP per cell is active, which gives the strongest signal towards to scheduled UE.

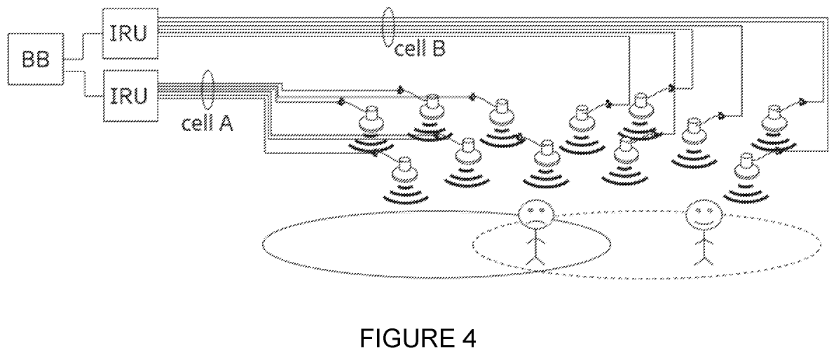

As shown in FIG. 5, the distance between receiving UE and the closest interfering TRP is increased as compared to previous techniques and systems such as those described above with respect to FIG. 4. As an increased distance between an aggressor transmitter and victim receiver gives rise to reduced interference signal powers, the SINR at the victim receiver may be improved.

According to certain embodiments, the TRP that maximizes the selection criteria is switched on, while all other TRPs in the cell are muted.

Previous techniques and methods disclose finding the suitable receiving points for selective combining in the uplink direction for Long Term Evolution (LTE). However, these techniques and methods may result in inefficient utilization of the available resources, in the way that only UEs that are within the coverage area of the active TRP can be served. If those UEs have sufficient data to fill the entire TTI, this is not a problem. In case a user has only a small amount of data to send, e.g. short packets that may only comprise a few bits of data, a large fraction of the available resources of one TTI remains idle. Such short packets with only a few information bits commonly occur in mobile broadband (MBB) smartphone traffic as well as traffic generated by industrial devices.

According to certain embodiments, however, the techniques, methods, and systems disclosed herein may include the following features that aim at mitigating idle transmission resources and distinguish over previous systems and techniques:
Select an optimal set of active TRPs to serve one or several UEs;
Schedule multiple UEs simultaneously with the limited set of active TRPs; and/or
Means to carry out the required measurements for active TRP selection.

Note that the above-mentioned methods may be used in combination as well as alternatively.

### Multiple Simultaneously Active TRPs Per Cell

According to certain embodiments, multiple TRPs may be simultaneously active per cell. By allowing more than one TRP to be simultaneously active, it may be possible to schedule several UEs at arbitrary locations simultaneously. Likewise, a UE that has similar, or at least sufficient, signal quality from several TRPs may be served by two or more of these TRPs. It is noted that, allowing more than one TRP to be active gives rise to increased inter-cell interference, so that in a particular embodiment, the scheduler may strive to minimize the number of simultaneously active TRPs, while keeping the loss due to idle transmission resources at acceptable levels.

### Schedule Multiple UEs Simultaneously

Certain embodiments may aim at mitigating the wasteful use of the available resources of a whole transmission time interval (TTI) being consumed with a short packet. For example, peak user bit rate supported with NR 100 MHz, 64 Quadrature Amplitude Modulation (QAM), 4×4 Multi-Input Multi-Output (MIMO) for downlink transmission is 1.65 Gbps (assuming 25% overhead). A short packet of 32 bytes sent every 1 ms offers negligible load of 256 kbps as compared to supported peak bit rate. This can be handled by grouping UEs according to the amount of data to be sent/received into 2 sets; set 1 and 2 containing UEs with long and short packets, respectively. A packet may be classified as long if it fills a substantial fraction of a TTI. UEs of set 1 are served with the TRP that provides the highest signal quality. UEs that belong to set 2, on the other hand, may be served by any TRP within the same cell that provides coverage. This gives an additional degree of freedom to the scheduler, in the way that UEs of set 2 with short packets can be scheduled on TTIs where their closest TRP is muted, i.e. the TRP with the highest signal quality towards that UE. In order to compensate for the compromised signal quality, the scheduler may assign a lower modulation and coding scheme (MCS) to UEs of set 2. Since set 2 UEs have comparably short packets, the added redundancy due to the lower MCS is likely to be lower than the loss in transmission opportunities due to idle resources.

### Measurements for Active TRP Selection

According to certain embodiments, the interpretation of a multi-TRP system as an active antenna system (AAS) may allow to inherit all NR beam management features. These features may include one or more of:
Active TRP selection with Channel State Information-Reference Signal (CSI-RS): configure CSI-RS measurements such that each TRP is assigned one set of CSI-RS. If the TRP is an AAS, then one CSI-RS is assigned to each beam. For classic non-AAS radios one CSI-RS is assigned per TRP (or possibly one CSI-RS per antenna branch for MIMO capable TRPs). Given that each TRP has M beams, this results in set of M×N CSI-RS per cell.
Active TRP selection with uplink Sounding Reference Signal (SRS): configure uplink SRS such that each UE sends an SRS that allows the baseband to measure the received signal strength for each TRP, by cyclically activating TRPs for SRS measurements.
Broadcast and common control channels: in 5G NR broadcast messages and common control signal are conveyed via synchronization signal blocks (SSB). In a preferred embodiment of the invention, one SSB comprises all N TRPs of one cell.
Random access procedure: uplink procedures where UEs are not associated to individual TRPs or cells, the receiver is reconfigured, such that all TRPs of one cell are active simultaneously.

### Implementation of on Off Switching

According to certain embodiments, it is assumed that the proposed dynamic on-off switching (DOOS) of TRPs operates on a TTI basis. The length of a TTI may depend on the system's capabilities and the specifications. DOOS is based on the idea that only TRPs that contribute to the desired signal are activated, while other TRPs are muted. This implies that some relation between TRPs and UEs needs to be established. Essentially, pairs of TRPs and UEs that form a good communication link are to be identified.

According to a particular embodiment, one possible criterion to associate TRPs with UEs is the reference signal received power (RSRP), which is commonly used for cell selection in wireless networks. A TRP is identified as serving node to a UE u, if it maximizes the RSRP among all TRPs n=1 . . . N, of one cell, that is

$$\hat{n} = {max}_{n} {RSPP}_{nu}$$

where RSRPₙᵤ denotes the RSRP between TRP n and user u. This ensures that a UE is served by the TRP that delivers the highest signal level.

According to another particular embodiment, an alternative criterion is to declare those TRPs as candidate servers who exceed a certain threshold RSRP, or who are within a certain range from the maximum RSRP_{flu}. This allows the scheduler to select between several candidate TRP servers, which provides a degree of freedom to schedule several UEs in one TTI. Hence, a more relaxed criterion of associating TRPs with UEs facilitates multi-user scheduling, i.e. serving multiple users within the same TTI.

According to certain embodiments, the baseband (BB) unit may not be aware that one cell consists of multiple TRPs. As the TRPs are connected to the IRU, the IRU may hide the TRPs from the BB. Additional control may be required between baseband and IRU to facilitate the active TRP selection. Moreover, the required measurements to identify the active TRPs would need to be defined and possibly standardized, as this involves exchange of control information between TRPs and UEs. To mitigate this problem, certain embodiments disclosed herein propose to apply the AAS framework, which is an integral part of the NR standard, in the way that we define a binary precoder of dimension N, denoted by w=[w₁, . . . , w_{N}]^{T}, with wₙϵ{0,1}, n=1 . . . N.

In the downlink, the transmitted signal of spatial stream i that leaves the BB at time sample k is denoted by sₖⁱ. Then the signal is expanded to dimension N, where N denotes the number of TRPs per cell, by multiplying each sample sₖⁱ with the precoder, given by xₖⁱ=sₖⁱ w, where xₖⁱ=[x₁ₖⁱ, . . . , x_{Nk}ⁱ]^{T} is of dimension N.

The active TRPs, given by the non-zero elements of w, resemble a spatial beam towards the scheduled UEs, even though the TRP itself may not use any beamforming at all. Rather the area covered by one TRP, being smaller than the total coverage area of all TRPs in the same cell, is being viewed as beam in this context. The same precoder w is applied to each spatial transmit and receive stream. For ease of notation, the index that accounts for the spatial stream i will therefore be omitted in the following.

According to certain embodiments, the TRP that maximizes the selection criteria, is switched on, while muting all other TRPs in the cell. In terms of the spatial precoder w, there is exactly one non-zero element w₁ per TTI. Further particular embodiments are described below.

For TRPs supporting multiple spatial streams (using multiple antenna branches), it is possible to do the switching separately for each antenna branch.

According to certain embodiments, the implementation of the switching that determines which TRP is activated or muted can be done at 3 physically different locations:
1. Switching in the IRU
2. Switching in the BB
3. Switching in the TRP
   Each are described below in more detail. There may be advantages from switching in more than one location (e.g. switching in TRP to reduce power consumption and switching in IRU to reduce downlink front-haul traffic).

Switching in the IRU

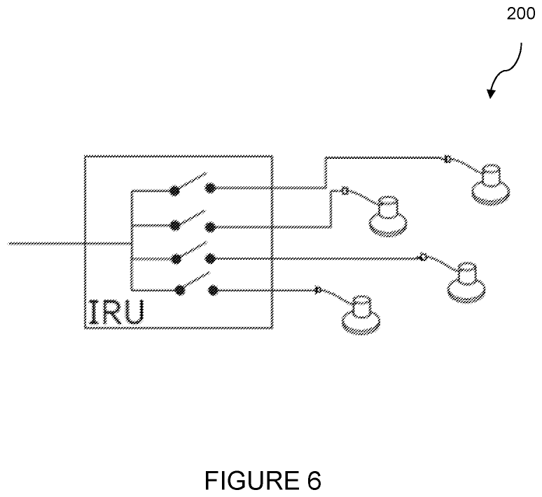

According to certain embodiments, the switching is performed in the IRU. FIG. 6 illustrates the switching apparatus 200 within the IRU, according to certain embodiments. More specifically, FIG. 6 illustrates an example switching apparatus 200 for activating/muting of radio TRPs with switches implemented at the IRU. For TRPs supporting multiple spatial streams (multiple antenna branches), there may be individually controlled switches for each antenna branch.

The n^{th} switch, with n=1, . . . , N, within the IRU is controlled by the n^{th} element of the precoder w, which is sent from the BB via the CPRI or eCPRI interface. A precoder value of wₙ=1 translates to a closed switch, which means that TRP n is active. Likewise, a precoder value of wₙ=0 translates to an open switch, which means that TRP n is muted. A functionally equivalent implementation would be to multiply each sample of the n^{th} branch sₖₙ by the precoder element wₙ. or in vector notation by sₖ w, which has been described previously. A more powerful IRU supporting multiple sectors (cells) might have additional or more advanced switches, allowing selection of which sector a TRP should belong to, but this does not change the basic idea of the invention.

Switching in the BB

According to certain embodiments, the switching may be performed in the BB. In a particular embodiment, for example, the switching apparatus within the BB may be carried out analogous to the IRU apparatus. In a particular embodiment, the switches need to be located where the transmitted signal stream sₖ is being expanded to N branches.

Switching in the TRP

According to certain embodiments, signaling a TRP when to send/receive implies that the n^{th} element of the precoder wₙ needs to be conveyed to the TRP. This may be done through an existing control link that may share the same physical cable as the transmitted/received signal.

The advantage of implementing the switching in the TRP is that for downlink transmission the power amplifier may be switched to a low-power mode if the TRP is muted, which improves the network's energy performance.

### Uplink Combining

According to certain embodiments, the same apparatus that carries out the switching operation may be used for both downlink and uplink. However, in the uplink there are different possibilities for combining the active branches. The received uplink signal at time sample k that impinges at receive antenna j of TRP n is denoted as rₙₖ^{j}.

Incoherent Combining

According to certain particular embodiments, the signal branches are simply added without correcting the phases of the received signal. This method is of low complexity but comparably poor performance. The combiner w determines which TRPs are actively contributing to the aggregated received signal that is fed to the BB, by multiplying the received signal of sample k of all branches with the combiner, given in vector notation by yₖ^{j}=rₖ^{j}w^{T}=Σₙ^{N}rₙₖ^{j}wₙ, where rₖ^{j}=[r₁ₖ^{j}, r_{Nk}^{j}]^{T} is the received signal stream of all N TRPs. It is seen that all receiving TRPs for which wₙ=0 are being removed from the received signal, while contributions from receiving TRPs for which wₙ=1 are being non-coherently combined.

It may be noted that gains of dynamic on-off switching are largest for incoherent combining. Thermal noise is reduced by the factor N-Σw, where Σw is the sum over the precoder w, which is equal to the number of non-zero elements of w. Moreover, the amount of interference is reduced, as any interference received by muted TRPs is removed.

Coherent Combining

According to certain particular embodiments, for coherent combining such as maximum ratio combining (MRC) or interference rejection combining (IRC), the received signal at receive antenna j of TRP n, rₙₖ^{j}, for which wₙ=1, are passed for further processing, while the signal contributions from the remaining TRPs are discarded. Subsequently, the remaining received signal branches are coherently combined according to the specific receiver implementation. Coherent combining results in improved signal quality, however, channel estimation and further signal processing for each active TRP is required, which adds to the computational complexity.

### Performance Evaluation

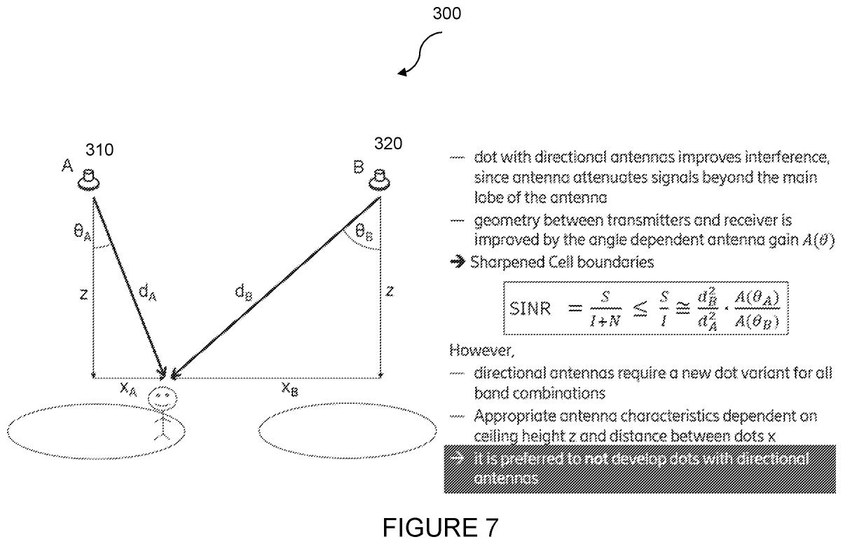

According to certain embodiments, in open environments the interference is determined by the geometry of the victim receiver towards the intended transmitter and the aggressor interferer. FIG. 7 illustrates a simple example system 300 with 2 TRPs, TRP A 310 and TRP B 320, according to certain embodiments. More specifically, FIG. 7 illustrates interference in open environments. In case the interference power is much larger than thermal noise, the SINR is determined by the geometry of the victim receiver towards the intended transmitter, TRP A 310, and the aggressor interferer, TRP B 320.

In FIG. 7, TRP A 310 is located d_{A} meters away from its intended receiver, whereas an aggressor interferer is located dB meters away from that receiver. In the absence of walls or any obstacles that block the direct line of sight between TRPs and receiver, the SINR can be approximated by

$$SINR = \frac{S}{I + {N}_{0}} \leq \frac{S}{I} ≅ \frac{{d}_{B}^{2}}{{d}_{A}^{2}} \cdot \frac{A ( {θ}_{A} )}{A ( {θ}_{B} )}$$

where No accounts for the mean thermal noise power, S is the received signal power at the receiver from its intended source A, and I is the interference power from the aggressor TRP B 320. Furthermore A(θ_{A}) and A(θ_{B}) are the antenna gains at the incident angles from A and B, respectively. In case, the interference is much larger than thermal noise, I [symbol] N₀, the SINR is determined by the ratio of the squared distances of the receiver towards the source and the interference times the ratio of their respective antenna gains. Hence, increasing the distance between victim receiver and source of the interference is key to improving the SINR in an interference limited environment. It can also be inferred from FIG. 7, that the detrimental effects of interference are aggrieved in case the transmitter is mounted high up (large z in FIG. 7 Error! Reference source not found.).

The performance improvement is exemplified for a RDS deployed in a large factory hall of dimension 180×90 m. The 3^{rd} Generation Partnership Project (3GPP) channel model to model industrial scenarios [1] is used. The SINR cdf is shown for low, medium and high system loads. For uplink transmission non-coherent combining is assumed. It is seen that the SINR of DOOS improves substantially at increasing system loads. For high loads the SINR of DOOS improves over a prior art multi-TRP system by 10-30 dB on the downlink, while uplink gains are in the range 10-20 dB. For uplink transmission, the power control Signal to Noise Ratio (SNR) target is set to 20 dB, and at low loads all users achieve their SNR target for both DOOS and the prior art multi-TRP system.

A comparison of a cumulative distribution function (CDF) for a previous multi-TRP system (label dot) and a CCF 450 of the dynamic on-off switching (DOOS) multi-TRP system (label DOOS), as disclosed herein, demonstrates that the SINR of DOOS improves substantially at increasing system loads.

### Multi-User Scheduling

Multi-user scheduling means to schedule multiple users in the same TTI. This increases efficiency, especially for UEs that only need to transmit or receive a small amount of data.

Muting of Individual Spatial Streams Per TRP

Multi-user scheduling in cells with multiple spatial streams (MIMO layers) can be implemented by selective muting of spatial streams so that only a subset of the supported spatial streams is used in a specific TRP. Then, one or more other TRPs could use the remaining spatial streams. For example, if 4 spatial streams are supported in a given cell, a first TRP could use 2 spatial streams to communicate with UE A, while a second TRP could use 1 spatial stream to communicate with UE B, and a third TRP could use the remaining spatial stream for UE C. In this example, each spatial stream is only active in one TRP at the time but it is also possible that some spatial streams are active in more than one TRP.

The following two sections discuss methods to support multi-user scheduling that work even when each cell and/or TRP only supports a single spatial (MIMO) layer.

Multiple Simultaneously Active TRPs Per Cell

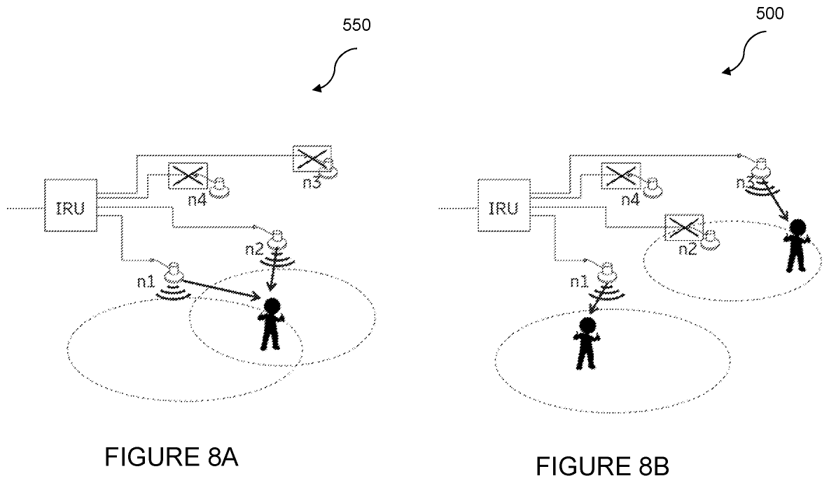

According to certain embodiments, allowing more than one TRP per cell to be active, it may be possible to schedule several UEs at arbitrary locations simultaneously. Likewise, a UE that has similar signal quality from several TRPs may be served by 2 or more of these TRPs. FIGS. 8A and 8B illustrate systems 500 and 550 having multiple simultaneously active TRPs per cell, according to certain embodiments. Specifically, FIG. 8A illustrates system 500 where TRPs n1 and n2 serve one user, and FIG. 8B illustrates system 550 where TRPs n1 and n3 serve 2 users being located far apart, according to certain embodiments. Allowing more than one TRP to be active gives rise to increased inter-cell interference, so that in a preferred embodiment the scheduler strives to minimize the number of simultaneously active TRPs, while keeping the loss due to idle transmission resources at acceptable levels.

One means to strike a balance between muting as many TRPs as possible and efficient resource utilization is to only allow UEs with poor received signal levels to be served with more than one TRP. This improves the received signal level for those users that need it most. The signal strength may be derived from the reference signal received power (RSRP) that may be compared to a fixed threshold.

Stringent latency requirements may be addressed by activating several TRPs, so that multiple UEs located far apart can be served within the same TTI. It is important to note that only a certain fraction of transmissions should be allowed to activate additional TRPs. An overloaded system may lead to extended delays in successfully delivering a packet, in which case activating additional TRPs is counter-productive and could lead to degraded performance, due to the additional interference.

Schedule Multiple UEs Simultaneously

Group UEs according to the amount of data to be sent/received into 2 sets; set 1 and 2 containing UEs with large amount of data and small amount of data, respectively. To simplify, in the further description, a large amount of data is referred to as a “long packet,” while a small amount of data is referred to as a “short packet.” A packet here may be classified as long if it occupies a substantial fraction of a TTI. UEs of set 1 are served with the TRP that provides the highest signal quality. Let the RSRP of TRP n at mobile u by denoted by RSRPₙᵤ, the serving TRP for users of set 1 is determined by

$$\hat{n} = {max}_{n} {RSPP}_{nu}$$

UEs that belong to set 2, on the other hand, may be served by any TRP within the same cell that provides sufficient signal quality to establish a communication link. So, any user u whose received signal level from the selected TRP n exceeds a certain threshold, RSRPₘᵢₙ, such that

RSRP\hat{n}ᵤ>RSRPₘᵢₙ

may be selected by the scheduler. This gives an additional degree of freedom to the scheduler, in the way that set 2 UEs with short packets, can be scheduled on TTIs where their closest TRP is muted. In order to compensate for the compromised signal quality, the scheduler may assign a lower modulation and coding scheme (MCS) to UEs of set 2. Since set 2 UEs have comparably short packets, the added redundancy due to the lower MCS is lower than the loss in transmission opportunities due to idle resources.

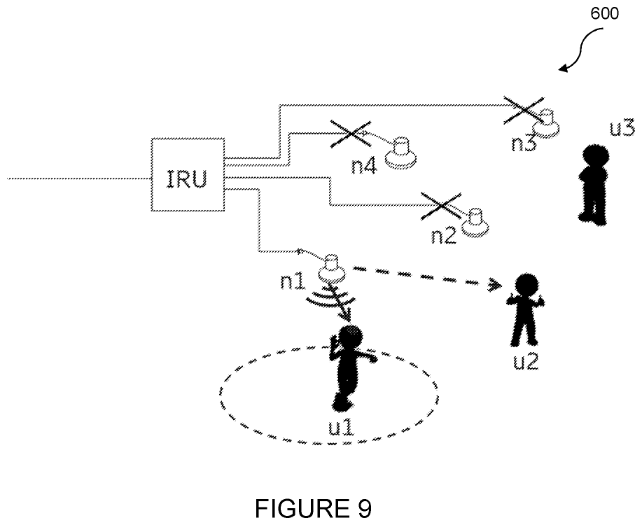

FIG. 9 illustrates an example DOOS scenario 600, according to a particular embodiment where three users, 2 users with long packets, and one user with a short packet, can be served within 2 TTIs, instead of 3 TTIs for the prior art scheduler. As illustrated, three users u1, u2 and u3 wish to send/receive data. While users u1 and u3 have long packets, user u2 have a short packet. We propose to schedule user's u2 short packet together with user's u1 packet from TRP n1. Note that user u2 is served by the TRP that is closest to user u1, while the TRP closest to user u2 remains muted.

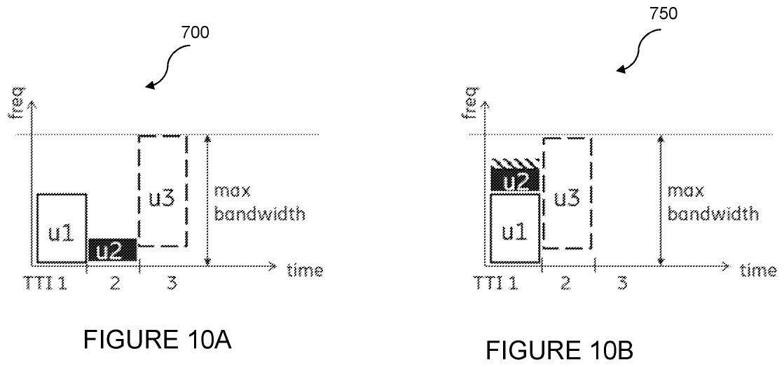

FIG. 10A illustrates example frequency-time resources 700 allocated using previous techniques for scheduling where users are served by the closest TRP only. This may be compared to FIG. 10B which illustrates example frequency-time resources 750 allocated using the techniques disclosed herein for DOOS scheduling, where users with short packets are served by TRPs that may not have the best link. In this example user u2, which intends to send/receive a short packet is scheduled in the same TTI as user u1. To compensate for the somewhat poorer communication link, additional redundancy is added. As both user u1 and u2 data is sent at the same TTI, which allows user u3 data to be sent one TTI earlier than with the prior art scheduler.

### Measurements for Active TRP Selection

According to certain embodiments, the interpretation of a multi-TRP system as a distributed Active Antenna System (AAS) allows to inherit all 5G NR beam management features. See, M. Giordani, M. Polese, A. Roy, D. Castor, M. Zorzi, “A Tutorial on Beam Management for 3GPP NR at mmWave Frequencies”, IEEE Communications Surveys & Tutorials, Volume 21, Issue 1, Q1 2019.

### Downlink Multi-TRP Management

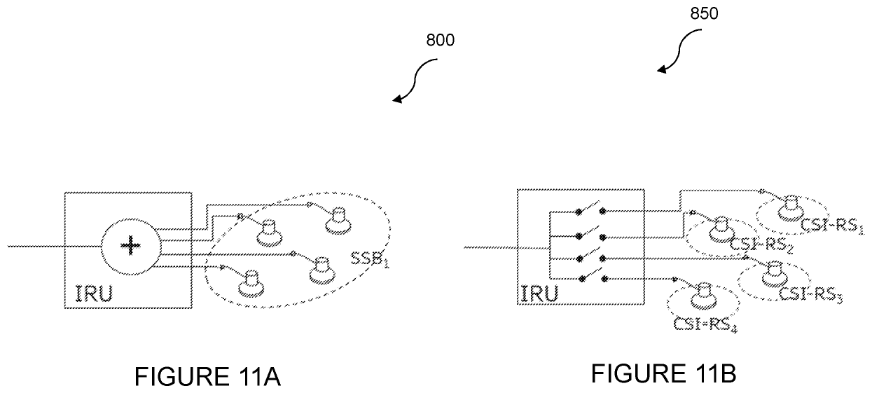

FIGS. 11A and 11B illustrate downlink, multi-TRP management. Specifically, FIG. 11A illustrates an example system 800 broadcast and common control channels, and FIG. 11B illustrates an example set up 850 for CSI-RS transmission.

With regard to FIG. 11A and the example system 800 for broadcast and common control channels, in 5G NR broadcast messages and common control signal are conveyed via synchronization signal blocks (SSB). In a particular embodiment, one SSB comprises all N TRPs of one cell. In terms of the spatial precoder w, this translates to an all-one array w, such that wₙ=1, for all nϵN. Multiple SSBs may be configured for one cell as well, according to the specifications of the 5G NR standard. In the illustrated example of FIG. 11A, one IRU serves 4 TRPs that form SSB₁.

When multiple SSBs are configured in a cell, different SSB (time) indices are applied. This was designed by 3GPP so that a 5G NR AAS could apply beamforming to SSBs (to get better coverage) by sending different SSBs in different beams (beam sweeping). UEs will measure on different beams and select the SSB index with the strongest signal (or the SSB index where the signal is above a threshold). For each SSB index, there is a corresponding set of random-access resources at a known instance in time. This allows the AAS to apply beamforming to the uplink random access as well. By using the corresponding set of random-access resources, the UE informs the base station about its best SSB index and thereby also the best beam. In 5G NR beam management, this procedure, to establish a wide beam covering the UE is called procedure P1. Herein, the concept of beam sweeping is utilized but it is applied to TRPs or groups of TRPs instead of directional beams from a single location. If a cell is subdivided into smaller groups of TRPs with different SSB indices, the utilized set of uplink random access resources from a UE will provide information about which group of TRPs the UE is best served by.

With regard to FIG. 11B and the example setup 850 for active TRP selection with CSI-RS, CSI-RS measurements may be configured such that each TRP is assigned one CSI-RS (or possibly one per spatial stream or antenna port for multi-antenna TRPs). This results in set of N CSI-RS per cell. In order to measure the signal strength, CSI-RS are periodically or aperiodically transmitted, in the way that CSI-RS₁ to CSI-RS_{N} are transmitted consecutively. During the transmission of CSI-RS of TRP n, denoted by CSI-RSₙ, the associated TRP n is activated, while all other TRPs within the same cell are muted. In the example set up 850 of FIG. 111B, one IRU serves 4 TRPs, and each TRP is assigned a CSI-RS.

In 5G NR beam management, this corresponds to procedure P2, where a wide beam based on SSB is refined using CSI-RS, to get UE-specific beam. In this invention, different CSI-RS are sent from different TRPs instead of using different narrow beams as in an AAS. Release 15 of 5G NR supports up to 32-port CSI-RS, using different combinations of time-, frequency-, and code-multiplexing. Here, it is preferred to assign different time-instances to different TRPs, while frequency- and code-multiplexing of CSI-RS can be used to support multiple antenna ports (or spatial streams) per TRP. This allows, e.g. 4 TRPs with 8-antennas each to share a single SSB index. If CSI-RS for different TRPs are separated in time-domain, a relatively simple switching scheme can be used as in FIG. 11B. If CSI-RS for different TRPs are sent in the same Orthogonal Frequency Division Multiplexing (OFDM) symbol but separated in frequency domain, a more complicated arrangement (e.g. filtering) might be needed unless frequency-domain processing is possible (e.g. if frequency-domain IQ samples are sent over the interface between IRU and TRP instead of time-domain IQ samples).

If it is necessary to support more than 4 TRPs per SSB index using time-multiplexing of CSI-RS, it is possible to apply different muting pattern to different instances of CSI-RSₙ. However, this increases solution complexity since BB or the IRU need to keep track of which muting pattern that was used.

Uplink Multi-TRP Management

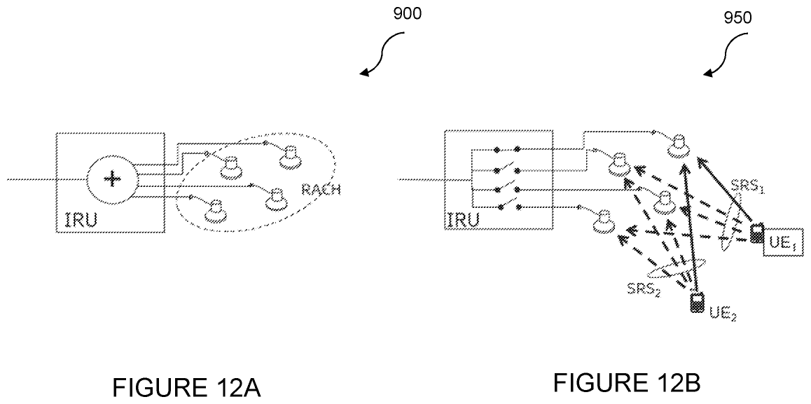

FIGS. 12A and 12B illustrates uplink, multi-TRP management, according to certain embodiments. Specifically, FIG. 12A illustrates an example system 900 for random access channel (RACH) and common control channels, and FIG. 12B illustrates an example setup 950 for SRS reception.

With regard to FIG. 12A and the example system 900 for the random access procedure, which includes uplink procedures where UEs are not associated to individual TRPs, the precoder w may also be configured as an all-one array, such that w₁=1, for all nϵN. For random access, the random access channel is received by all TRPs and combined at the IRU. FIG. 12A illustrates the example system 900 where one IRU receives random access messages by combining the signal of all 4 TRPs connected to that IRU. This would be the case if all 4 TRPs share a common SSB index in the P1 procedure.

With regard to FIG. 12B and the example setup 950 for active TRP selection with uplink SRS, uplink SRS may be configured such that each UE sends an SRS that allows each TRP to measure the received signal strength of that UE. Since there is only one receiving chain after signal combining at the IRU, the uplink SRS must be transmitted N times, where N is the number of TRPs connected to the IRU. For each of these N SRS transmissions, the N TRPs are cyclically activated, while the remaining TRPs remain muted. The example setup 950 of FIG. 12B illustrates the SRS reception for two UEs.

Scheduling Constraints

According to certain embodiments, the scheduler can take any one or more of the following into account for making the scheduling decision: link information, number of already active TRPs and packet delay budget. For example, if the number of already active TRPs are large, then the scheduler can postpone serving the user in the same TTI, in a particular embodiment. As another example, if the packet delay budget is too strict, then the scheduler can attempt to serve the additional user at the cost of creating more interference (enabling more TRPs), in a particular embodiment.

The dynamic selection of the active TRP applies to both downlink and uplink directions. While in many cases the same TRP may serve a user on both uplink and downlink, the selection for uplink and downlink may also be done independently. In this way, two different TRPs can be selected to serve the same user in both uplink and downlink. While this disclosure focuses on 5G NR technology, it is generally recognized that the techniques and methods disclosed herein are generally applicable to any mobile communication standard, such as, for example, 3G High Speed Packet Access (HSPA) or LTE. Example network and network node embodiments are described below.

In summary, the dynamic selection of active TRPs for serving users involves, first, finding the best-candidate TRPs for each user to be served. Then, using this information, a scheduling decision is made in each TTI. The criteria for selecting the best-candidate TRP for a particular user may be received signal power, which for NR may be derived from CSI-RS and/or uplink SRS, in a particular embodiment. In a further embodiment, the selection criteria may be the SINR, which can be derived from channel quality indicator (CQI) reports of the UE.

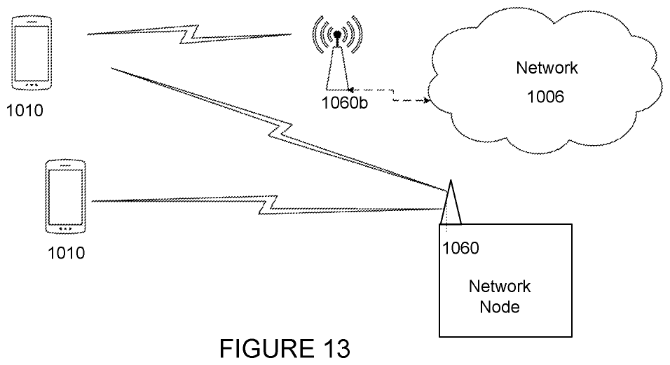

FIG. 13 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1006, network nodes 1060 and 1060b, and wireless devices 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and wireless device 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

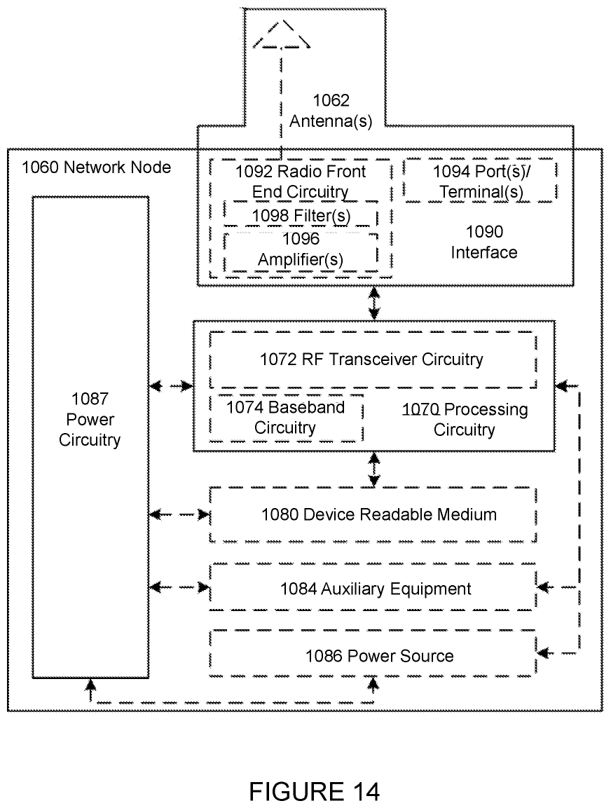

FIG. 14 illustrates an example network node 1060, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 14, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, Wide Code Division Multiplexing Access (WCDMA), LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units.

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060 but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or wireless devices 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or wireless devices via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 14 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

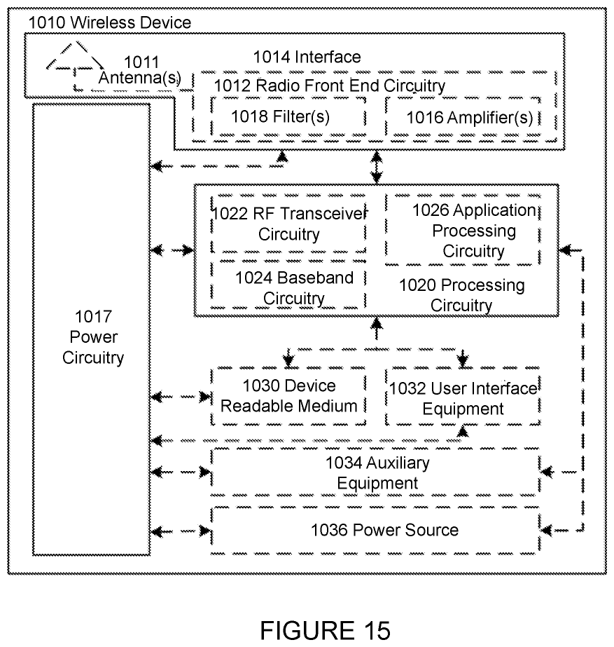

FIG. 15 illustrates an example wireless device 1010. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. Wireless device 1010 may include multiple sets of one or more of the illustrated components for different wireless technologies supported by wireless device 1010, such as, for example, GSM, WCDMA, LTE, NR, WiFi, WiMAX, or Bluetooth wireless technologies, just to mention a few. These wireless technologies may be integrated into the same or different chips or set of chips as other components within wireless device 1010.

Antenna 1011 may include one or more antennas or antenna arrays, configured to send and/or receive wireless signals, and is connected to interface 1014. In certain alternative embodiments, antenna 1011 may be separate from wireless device 1010 and be connectable to wireless device 1010 through an interface or port. Antenna 1011, interface 1014, and/or processing circuitry 1020 may be configured to perform any receiving or transmitting operations described herein as being performed by a wireless device. Any information, data and/or signals may be received from a network node and/or another wireless device. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020 and is configured to condition signals communicated between antenna 1011 and processing circuitry 1020. Radio front end circuitry 1012 may be coupled to or a part of antenna 1011. In some embodiments, wireless device 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or wireless devices via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 1010 components, such as device readable medium 1030, wireless device 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of wireless device 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a wireless device may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of wireless device 1010, but are enjoyed by wireless device 1010 as a whole, and/or by end users and the wireless network generally.

Processing circuitry 1020 may be configured to perform any determining, calculating, or similar operations (e.g., certain obtaining operations) described herein as being performed by a wireless device. These operations, as performed by processing circuitry 1020, may include processing information obtained by processing circuitry 1020 by, for example, converting the obtained information into other information, comparing the obtained information or converted information to information stored by wireless device 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with wireless device 1010. Such interaction may be of many forms, such as visual, audial, tactile, etc. User interface equipment 1032 may be operable to produce output to the user and to allow the user to provide input to wireless device 1010. The type of interaction may vary depending on the type of user interface equipment 1032 installed in wireless device 1010. For example, if wireless device 1010 is a smart phone, the interaction may be via a touch screen; if wireless device 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into wireless device 1010 and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from wireless device 1010, and to allow processing circuitry 1020 to output information from wireless device 1010. User interface equipment 1032 may include, for example, a speaker, a display, vibrating circuitry, a USB port, a headphone interface, or other output circuitry. Using one or more input and output interfaces, devices, and circuits, of user interface equipment 1032, wireless device 1010 may communicate with end users and/or the wireless network and allow them to benefit from the functionality described herein.

Auxiliary equipment 1034 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. wireless device 1010 may further comprise power circuitry 1037 for delivering power from power source 1036 to the various parts of wireless device 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case wireless device 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of wireless device 1010 to which power is supplied.

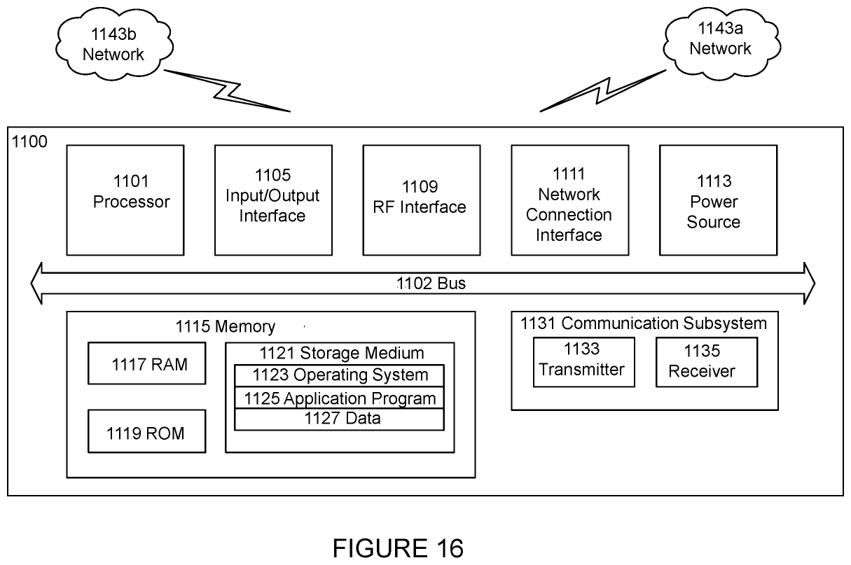

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3^{rd} Generation Partnership Project (3GPP), including a NB-IoT UE, a machine type communication (MTC) UE, and/or an enhanced MTC (eMTC) UE. UE 1100, as illustrated in FIG. 16, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 16 is a UE, the components discussed herein are equally applicable to a wireless device, and vice-versa.

In FIG. 16, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 16, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another wireless device, UE, or base station of a radio access network (RAN) according to one or more communication protocols, such as IEEE 802.11, Code Division Multiplexing Access (CDMA), WCDMA, GSM, LTE, Universal Terrestrial Radio Access Network (UTRAN), WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

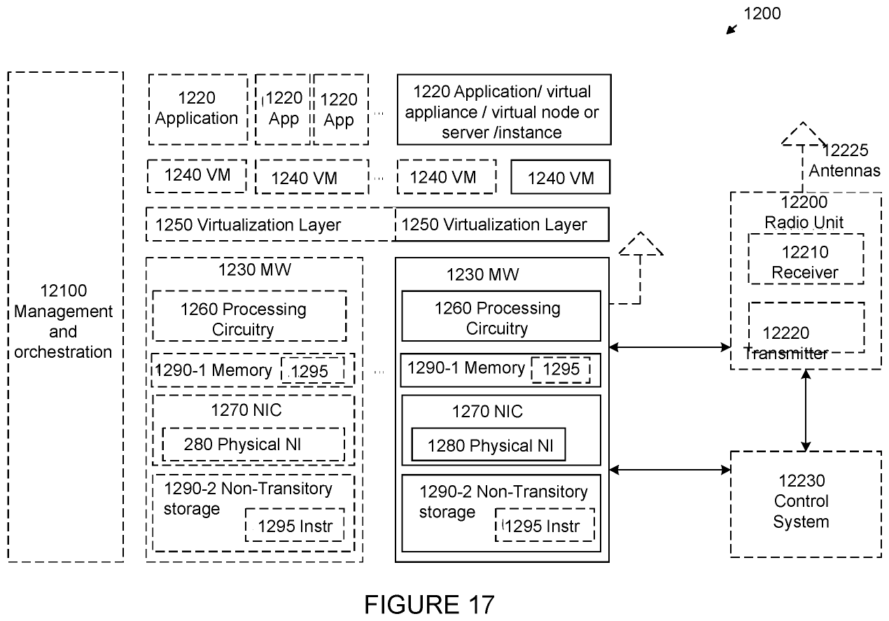

FIG. 17 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 17, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 17.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signaling can be affected with the use of control system 12230 which may alternatively be used for communication between the hardware nodes 1230 and radio units 12200.

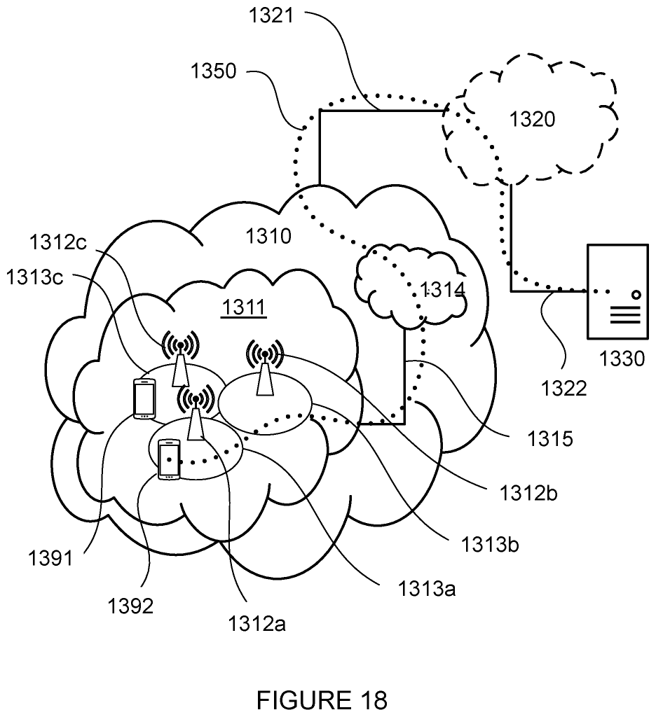

FIG. 18 illustrates a telecommunication network connected via an intermediate network to a host computer in accordance with some embodiments.

With reference to FIG. 18, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 18 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

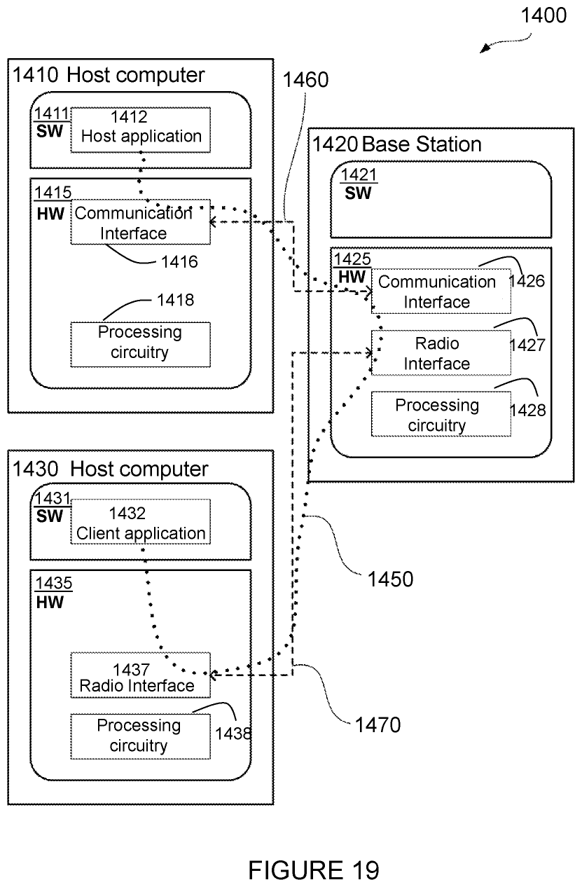

FIG. 19 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 19. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 19) served by base station 1420. Communication interface 1426 may be configured to facilitate connection 1460 to host computer 1410. Connection 1460 may be direct or it may pass through a core network (not shown in FIG. 19) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 19 may be similar or identical to host computer 1330, one of base stations 1312a, 1312b, 1312c and one of UEs 1391, 1392 of FIG. 18, respectively. This is to say, the inner workings of these entities may be as shown in FIG. 19 and independently, the surrounding network topology may be that of FIG. 18.

In FIG. 19, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

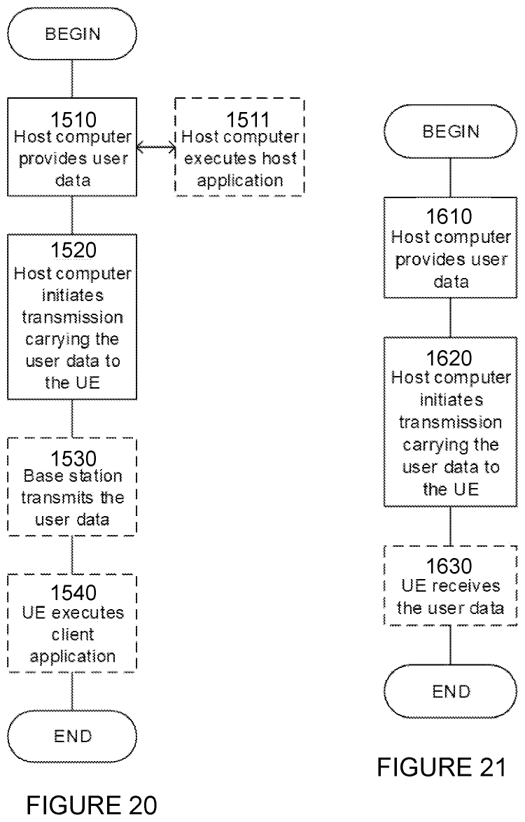

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

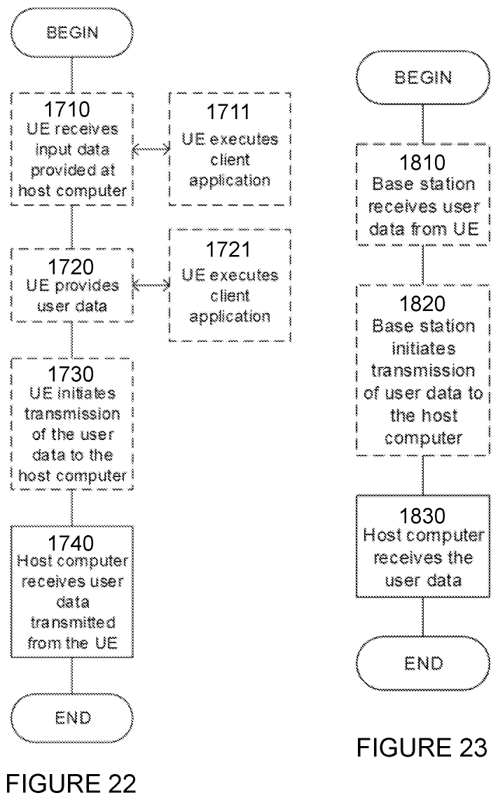

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

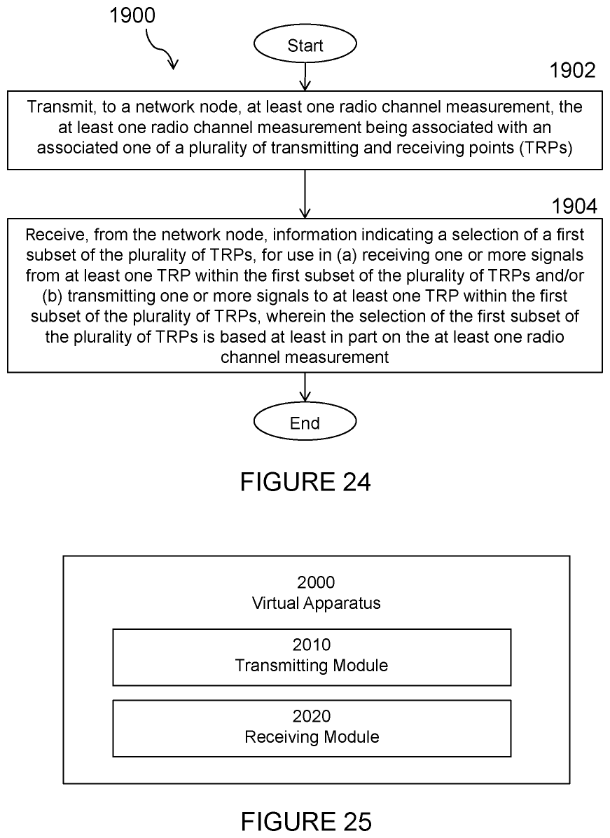

FIG. 24 depicts a method 1900 by a wireless device, according to certain embodiments. At step 1902, the wireless device transmits, to a network node, at least one radio channel measurement, the at least one radio channel measurement being associated with an associated one of a plurality of transmitting and receiving points (TRPs). At step 1904, the wireless device receives, from the network node, information indicating a selection of a first subset of the plurality of TRPs, for use in (a) receiving one or more signals from at least one TRP within the first subset of the plurality of TRPs and/or (b) transmitting one or more signals to at least one TRP within the first subset of the plurality of TRPs, wherein the selection of the first subset of the plurality of TRPs is based at least in part on the at least one radio channel measurement.

In a particular embodiment, the first subset of TRPs comprises a single TRP, the single TRP comprising at least one of a transmitter and a receiver.

In a particular embodiment, the first subset of TRPs comprises two or more TRPs, each of the two or more TRPs comprising at least one of a transmitter and a receiver.

In a particular embodiment, the wireless device transmits the one or more signals to at least one TRP within the first subset of the plurality of TRPs.

In a particular embodiment, the wireless device receives the one or more signals from at least one TRP within the first subset of TRPs.

In a particular embodiment, the wireless device receives information indicating a second subset of the TRPs that are muted with respect to (a) the one or more signals being received from the at least one TRP within the first subset of the plurality of TRPs and/or (b) the one or more signals being transmitted to the at least one TRP within the first subset of the plurality of TRPs.

In a particular embodiment, the at least one radio channel measurement comprises at least one Reference Signal Received Power (RSRP) measurement.

In a particular embodiment, the at least one radio channel measurement comprises at least one Reference Signal Received Quality (RSRQ) measurement.

In a particular embodiment, the first subset of the TRPs includes only the TRPs having an associated radio channel measurement that is equal to or greater than a threshold value.

In a particular embodiment, the first subset of the TRPs includes only a single TRP having a best radio channel measurement.

In a particular embodiment, the first subset of the TRPs does not include any TRPs having an associated radio channel measurement that is less than a threshold value.

In a particular embodiment, the first subset of the TRPs comprises a plurality of TRPs configured to be simultaneously active in a first cell.

In a particular embodiment, each TRP within the first subset of TRPs is configured to be simultaneously active in a first cell during a first transmission time interval (TTI).

In a particular embodiment, the first subset of the TRPs is associated with a plurality of wireless devices.

In a particular embodiment, each TRP within the first subset of the TRPs is associated with a respective one of a plurality of wireless devices.

In a particular embodiment, multiple TRPs within the first subset of the TRPs is associated with the wireless device. In a further particular embodiment, the at least one radio channel measurement is below a threshold value.

In a particular embodiment, the wireless device transmits, to the network node, location information associated with the wireless device, and the first subset of TRPs is selected based on the location information associated with the wireless device.

In a particular embodiment, the wireless device transmits information indicating an amount of data to be transmitted by the wireless device, and the first subset of TRPs is selected based on the information indicating the amount of data to be transmitted by the wireless device.

In a particular embodiment, the wireless device comprises a user equipment (UE).

FIG. 25 illustrates a schematic block diagram of a virtual apparatus 2000 in a wireless network (for example, the wireless network shown in FIG. 13). The apparatus may be implemented in a wireless device or network node (e.g., wireless device 1010 or network node 1060 shown in FIG. 13). Apparatus 2000 is operable to carry out the example method described with reference to FIG. 24 and possibly any other processes or methods disclosed herein. It is also to be understood that the method of FIG. 24 is not necessarily carried out solely by apparatus 2000. At least some operations of the method can be performed by one or more other entities.

Virtual Apparatus 2000 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 2010, receiving module 2020, and any other suitable units of apparatus 2000 to perform corresponding functions according one or more embodiments of the present disclosure.

According to certain embodiments, transmitting module 2010 may perform certain of the transmitting functions of the apparatus 2000. For example, transmitting module 2010 may transmit, to a network node, at least one radio channel measurement, the at least one radio channel measurement being associated with an associated one of a plurality of transmitting and receiving points (TRPs).

According to certain embodiments, receiving module 2020 may perform certain of the receiving functions of the apparatus 2000. For example, receiving module 2020 may receive, from the network node, information indicating a selection of a first subset of the plurality of TRPs, for use in (a) receiving one or more signals from at least one TRP within the first subset of the plurality of TRPs and/or (b) transmitting one or more signals to at least one TRP within the first subset of the plurality of TRPs. The selection of the first subset of the plurality of TRPs is based at least in part on the at least one radio channel measurement.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

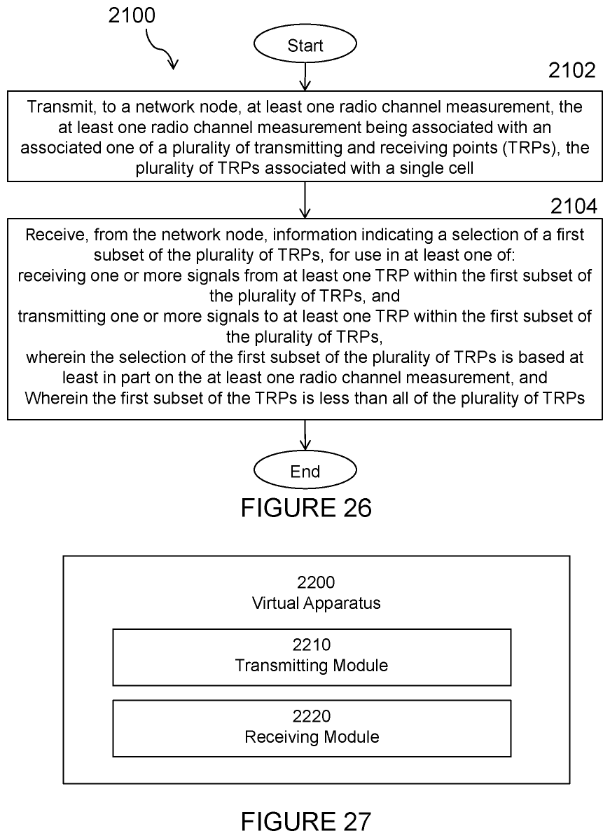

FIG. 26 depicts another method 2100 by a wireless device 1010, according to certain embodiments. At step 2102, the wireless device 1010 transmits, to a network node 1060, at least one radio channel measurement. The at least one radio channel measurement is associated with an associated one of a plurality of TRPs, and the plurality of TRPs are associated with a single cell. At step 2104, the wireless device 1010 receives, from the network node 1060, information indicating a selection of a first subset of the plurality of TRPs, for use in at least one of receiving one or more signals from at least one TRP within the first subset of the plurality of TRPs and/or transmitting one or more signals to at least one TRP within the first subset of the plurality of TRPs. The selection of the first subset of the plurality of TRPs is based at least in part on the at least one radio channel measurement, and the first subset of the TRPs is less than all of the plurality of TRPs.

In a particular embodiment, a second subset of the TRPs are muted with respect to at least one of: the one or more signals being received from the at least one TRP within the first subset of the plurality of TRPs; and the one or more signals being transmitted to the at least one TRP within the first subset of the plurality of TRPs.

In a particular embodiment, the information indicating the selection of the first subset of the TRPs comprises information indicating a selection of at least one antenna on at least one TRP in the first subset of the TRPs.

In a particular embodiment, each of the TRPs has an antenna corresponding to an antenna of each other of the TRPs in the plurality of TRPs, and the information indicating the selection of the TRPs comprises information indicating that the corresponding antennas of each of the TRPs are selected.

In a particular embodiment, the first subset of TRPs comprises a single TRP, and the single TRP comprising at least one of a transmitter and a receiver.

In a particular embodiment, the first subset of TRPs comprises two or more TRPs, and each of the two or more TRPs comprising at least one of a transmitter and a receiver.

In a particular embodiment, the wireless device 1010 transmits the one or more signals to the at least one TRP within the first subset of the plurality of TRPs.

In a particular embodiment, the wireless device 1010 receives the one or more signals from the at least one TRP within the first subset of TRPs.

In a particular embodiment, the at least one radio channel measurement comprises at least one RSRP measurement.

In a particular embodiment, the at least one radio channel measurement comprises at least one RSRQ measurement.

In a particular embodiment, the first subset of the TRPs includes only the TRPs having an associated radio channel measurement that is equal to or greater than a threshold value.

In a particular embodiment, the first subset of the TRPs includes only a single TRP having a best radio channel measurement.

In a particular embodiment, the first subset of the TRPs comprises a plurality of TRPs configured to be simultaneously active in the single cell.

In a particular embodiment, each TRP within the first subset of TRPs is configured to be simultaneously active in the single cell during a first TTI.

In a particular embodiment, the first subset of the TRPs is associated with a plurality of wireless devices. In a further particular embodiment, each TRP within the first subset of the TRPs is associated with a respective one of the plurality of wireless devices. In another particular embodiment, multiple TRPs within the first subset of the TRPs is associated with the wireless device.

In a particular further embodiment, the at least one radio channel measurement is below a threshold value, and the wireless device 1010 is associated with the multiple TRPs based on the at least one radio channel measurement being below the threshold value.

In a particular embodiment, the wireless device 1010 transmits, to the network node 1060, location information associated with the wireless device 1010, and the information indicates the selection of the first subset of TRPs is based on the location information associated with the wireless device 1010.

In a particular embodiment, the wireless device 1010 transmits information indicating an amount of data to be transmitted by the wireless device 1010, and the information indicating the selection of the first subset of TRPs is based on the information indicating the amount of data to be transmitted by the wireless device 1010.

In a particular embodiment, the wireless device is a UE.

FIG. 27 illustrates a schematic block diagram of a virtual apparatus 2200 in a wireless network (for example, the wireless network shown in FIG. 13). The apparatus may be implemented in a wireless device or network node (e.g., wireless device 1010 or network node 1060 shown in FIG. 13). Apparatus 2200 is operable to carry out the example method described with reference to FIG. 26 and possibly any other processes or methods disclosed herein. It is also to be understood that the method of FIG. 26 is not necessarily carried out solely by apparatus 22000. At least some operations of the method can be performed by one or more other entities.

Virtual Apparatus 2200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 2210, receiving module 2220, and any other suitable units of apparatus 2200 to perform corresponding functions according one or more embodiments of the present disclosure.

According to certain embodiments, transmitting module 2210 may perform certain of the transmitting functions of the apparatus 2200. For example, transmitting module 2210 may transmit, to a network node 1060, at least one radio channel measurement. The at least one radio channel measurement is associated with an associated one of a plurality of TRPs, and the plurality of TRPs are associated with a single cell.

According to certain embodiments, receiving module 2220 may perform certain of the receiving functions of the apparatus 2200. For example, receiving module 2220 may receive, from the network node 1060, information indicating a selection of a first subset of the plurality of TRPs, for use in at least one of: receiving one or more signals from at least one TRP within the first subset of the plurality of TRPs and/or transmitting one or more signals to at least one TRP within the first subset of the plurality of TRPs. The selection of the first subset of the plurality of TRPs is based at least in part on the at least one radio channel measurement, and the first subset of the TRPs is less than all of the plurality of TRPs.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

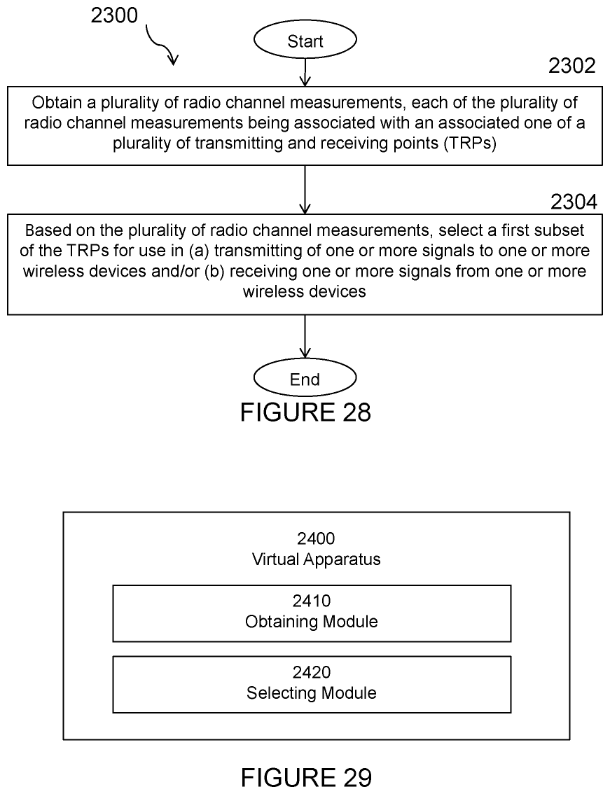

FIG. 28 depicts a method 2300 by a network node, according to certain embodiments. At step 2302, the network node obtains a plurality of radio channel measurements. Each of the plurality of radio channel measurements is associated with an associated one of a plurality of transmitting and receiving points (TRPs). At step 2304, based on the plurality of radio channel measurements, the network node selects a first subset of the TRPs for use in (a) transmitting of one or more signals to one or more wireless devices and/or (b) receiving one or more signals from one or more wireless devices.

In a particular embodiment, the first subset of TRPs comprises a single TRP. The single TRP comprises at least one of a transmitter and a receiver.

In a particular embodiment, the first subset of TRPs comprises two or more TRPs. Each of the two or more TRPs comprise at least one of a transmitter and a receiver.

In a particular embodiment, selecting the first subset of the TRPs comprises using at least one switch to enable the first subset of TRPs to (a) transmit the one or more signals to the one or more wireless devices and/or (b) receive the one or more signals from the one or more wireless devices.

In a particular embodiment, based on the plurality of radio channel measurements, the network node selects a second subset of the TRPs for muting with respect to (a) the one or more signals to be transmitted to the one or more wireless devices and/or (b) the one or more signals to be received from the one or more wireless devices. Each TRP within the second subset is not within the first subset of the TRPs. In a further particular embodiment, selecting the second subset of the TRPs for muting comprises using at least one switch to disable or block the second subset of TRPs from (a) transmitting the one or more signals to the one or more wireless devices and/or (b) receiving the one or more signals from the one or more wireless devices.

In a particular embodiment, the plurality of radio channel measurements comprise a plurality of Reference Signal Received Power (RSRP) measurements.

In a particular embodiment, the plurality of radio channel measurements comprise a plurality of Reference Signal Received Quality (RSRQ) measurements.

In a particular embodiment, selecting the first subset of the TRPs comprises including in the first subset only the TRPs having an associated radio channel measurement that is equal to or greater than a threshold value.

In a particular embodiment, selecting the first subset of the TRPs comprises including in the first subset only a TRP having a best radio channel measurement.

In a particular embodiment, selecting the first subset of the TRPs comprises not including in the first subset any TRPs having an associated radio channel measurement that is less than a threshold value.

In a particular embodiment, the first subset of the TRPs comprises a plurality of TRPs configured to be simultaneously active in a first cell, and each of the plurality of TRPs is selected for (a) transmission of a signal to at least one of a plurality of wireless devices and/or (b) reception of a signal from at least one of a plurality of wireless devices.

In a particular embodiment, each TRP within the first subset of TRPs is configured to be simultaneously active in a first cell during a first transmission time interval (TTI).

In a particular embodiment, the network node associates the first subset of the TRPs with a plurality of wireless devices.

In a particular embodiment, each TRP within the first subset of the TRPs is associated with a respective one of a plurality of wireless devices.

In a particular embodiment, multiple TRPs within the first subset of the TRPs are associated with a particular one of the plurality of wireless devices.

In a particular embodiment, the particular one of the plurality of wireless device is associated with multiple TRPs within the first subset in response to determining that at least one radio channel measurement is below a threshold value.

In a particular embodiment, the network node obtains location information associated with each one of the plurality of wireless devices, and the association of the first subset of TRPs with the plurality of wireless devices is based on the location information associated with each one of the plurality of wireless devices.

In a particular embodiment, the network node obtains information indicating an amount of data to be transmitted by each of the plurality of wireless devices, and the association of the first subset of TRPs with the plurality of wireless devices is based on the information indicating the amount of data to be transmitted by each of the plurality of wireless devices.

In a particular embodiment, the network node is a base station.

FIG. 29 illustrates a schematic block diagram of a virtual apparatus 2400 in a wireless network (for example, the wireless network shown in FIG. 13). The apparatus may be implemented in a wireless device or network node (e.g., wireless device 1010 or network node 1060 shown in FIG. 13). Apparatus 2400 is operable to carry out the example method described with reference to FIG. 28 and possibly any other processes or methods disclosed herein. It is also to be understood that the method of FIG. 28 is not necessarily carried out solely by apparatus 2400. At least some operations of the method can be performed by one or more other entities.

Virtual Apparatus 2400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining module 2410, selecting module 2420, and any other suitable units of apparatus 2400 to perform corresponding functions according one or more embodiments of the present disclosure.

According to certain embodiments, obtaining module 2410 may perform certain of the obtaining functions of the apparatus 2400. For example, obtaining module 2410 may obtain a plurality of radio channel measurements. Each of the plurality of radio channel measurements is associated with an associated one of a plurality of transmitting and receiving points (TRPs).

According to certain embodiments, selecting module 2420 may perform certain of the selecting functions of the apparatus 2400. For example, based on the plurality of radio channel measurements, selecting module 2420 may select a first subset of the TRPs for use in (a) transmitting of one or more signals to one or more wireless devices and/or (b) receiving one or more signals from one or more wireless devices.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

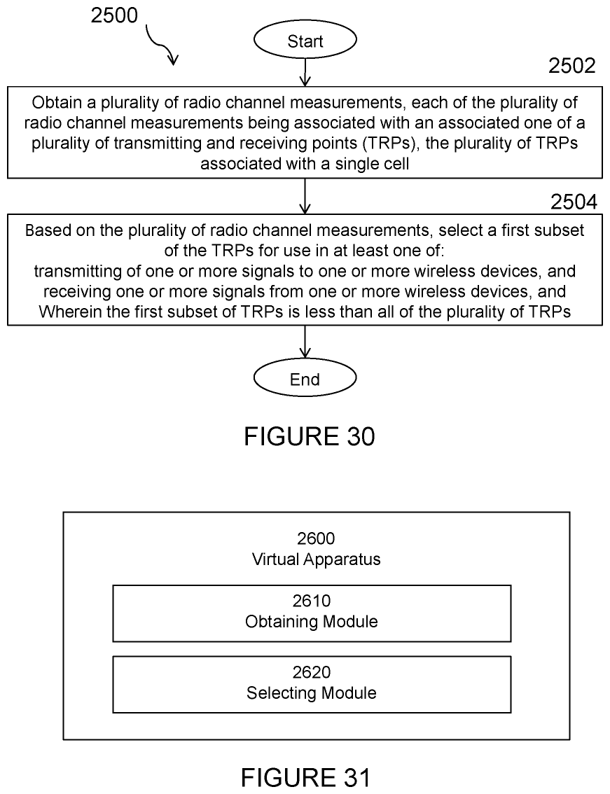

FIG. 30 depicts a method 2500 by a network node 1060, according to certain embodiments. At step 2502, the network node 1060 obtains a plurality of radio channel measurements. Each of the plurality of radio channel measurements is associated with an associated one of a plurality of TRPs, and the plurality of TRPs are associated with a single cell. Based on the plurality of radio channel measurements, at step 2504, the network node 1060 selects a first subset of the TRPs for use in at least one of: transmitting of one or more signals to one or more wireless devices; and receiving one or more signals from one or more wireless devices. The first subset of the TRPs is less than all of the plurality of TRPs.

In a particular embodiment, selecting the first subset of the TRPs comprises using at least one switch to enable the first subset of TRPs to at least one of: transmit the one or more signals to the one or more wireless devices 1010, and receive the one or more signals from the one or more wireless devices 1010.

In a particular embodiment, the network node 1060 selects, based on the plurality of radio channel measurements, a second subset of the TRPs for muting with respect to least one of: the one or more signals to be transmitted to the one or more wireless devices, and the one or more signals to be received from the one or more wireless devices, each TRP within the second subset not being within the first subset of the TRPs.

In a further particular embodiment, selecting the second subset of the TRPs for muting comprises using at least one switch to disable or block the second subset of TRPs from at least one of: transmitting the one or more signals to the one or more wireless devices 1010, and receiving the one or more signals from the one or more wireless devices 1010.

In a further particular embodiment, selecting the first subset of the TRPs comprises selecting at least one antenna on at least one TRP in the first subset of the TRPs.

In a particular embodiment, the network node 1060 receives a plurality of uplink signals from the one or more wireless devices 1010 and non-coherently combining the plurality of uplink signals.

In a particular embodiment, each of the TRPs has multiple corresponding antennas, and selecting the first subset of the TRPs comprises selecting the corresponding antennas on the TRPs for at least one of transmitting and receiving the one or more signals to the one or more wireless devices 1010.

In a particular embodiment, the first subset of TRPs comprises a single TRP, and the single TRP comprising at least one of a transmitter and a receiver.

In a particular embodiment, the first subset of TRPs comprises two or more TRPs, and each of the two or more TRPs comprises at least one of a transmitter and a receiver.

In a particular embodiment, the plurality of radio channel measurements include RSRP measurements.

In a particular embodiment, the plurality of radio channel measurements include RSRQ measurements.

In a particular embodiment, selecting the first subset of the TRPs comprises including in the first subset only the TRPs having an associated radio channel measurement that is equal to or greater than a threshold value.

In a particular embodiment, selecting the first subset of the TRPs comprises including in the first subset only a TRP having a best radio channel measurement.

In a particular embodiment, the first subset of the TRPs comprises a plurality of TRPs configured to be simultaneously active in the single cell, and each of the plurality of TRPs being selected for at least one of: transmission of the one or more signals to at least one of a plurality of wireless devices 1010, and reception of the one or more signals from at least one of a plurality of wireless devices 1010.

In a particular embodiment, each TRP within the first subset of TRPs is configured to be simultaneously active in the single cell during a first TTI.

In a particular embodiment, the network node 1060 associates the first subset of the TRPs with a plurality of wireless devices 1010. In a further particular embodiment, each TRP within the first subset of the TRPs is associated with a respective one of the plurality of wireless devices 1010.

In another particular embodiment, multiple TRPs within the first subset of the TRPs is associated with a particular one of the plurality of wireless devices 1010.

In a further particular embodiment, the particular one of the plurality of wireless devices 1010 is associated with multiple TRPs within the first subset of TRPs in response to determining that at least one radio channel measurement is below a threshold value.

In a particular embodiment, the network node 1060 obtains location information associated with each one of the plurality of wireless devices 1010, and the association of the first subset of TRPs with the plurality of wireless devices 1010 is based on the location information associated with each one of the plurality of wireless devices 1010.

In a particular embodiment, the network node 1060 obtains information indicating an amount of data to be transmitted by each of the plurality of wireless devices 1010, and the association of the first subset of TRPs with the plurality of wireless devices 1010 is based on the information indicating the amount of data to be transmitted by each of the plurality of wireless devices 1010.

In a particular embodiment, the network node 1060 is a base station.

FIG. 31 illustrates a schematic block diagram of a virtual apparatus 2600 in a wireless network (for example, the wireless network shown in FIG. 13). The apparatus may be implemented in a wireless device or network node (e.g., wireless device 1010 or network node 1060 shown in FIG. 13). Apparatus 2600 is operable to carry out the example method described with reference to FIG. 30 and possibly any other processes or methods disclosed herein. It is also to be understood that the method of FIG. 30 is not necessarily carried out solely by apparatus 2600. At least some operations of the method can be performed by one or more other entities.

Virtual Apparatus 2600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining module 2610, selecting module 2620, and any other suitable units of apparatus 2600 to perform corresponding functions according one or more embodiments of the present disclosure.

According to certain embodiments, obtaining module 2610 may perform certain of the obtaining functions of the apparatus 2600. For example, obtaining module 2610 may obtain a plurality of radio channel measurements. Each of the plurality of radio channel measurements is associated with an associated one of a plurality of TRPs, and the plurality of TRPs are associated with a single cell.

According to certain embodiments, selecting module 2620 may perform certain of the selecting functions of the apparatus 2600. For example, based on the plurality of radio channel measurements, selecting module 2620 may select a first subset of the TRPs for use in at least one of: transmitting of one or more signals to one or more wireless devices; and receiving one or more signals from one or more wireless devices. The first subset of the TRPs is less than all of the plurality of TRPs.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a wireless device, the method comprising:
transmitting, to a network node, at least one radio channel measurement, the at least one radio channel measurement being associated with an associated one of a plurality of transmitting and receiving points, TRPs, the plurality of TRPs associated with a single cell; and
receiving, from the network node, information indicating a selection of a first subset of the plurality of TRPs, for use in at least one of:
receiving one or more signals from at least one TRP within the first subset of the plurality of TRPs; and
transmitting one or more signals to at least one TRP within the first subset of the plurality of TRPs,
wherein the selection of the first subset of the plurality of TRPs is based at least in part on the at least one radio channel measurement, and
wherein the first subset of the TRPs is less than all of the plurality of TRPs.

2. The method of claim 2, wherein a second subset of the TRPs are muted with respect to at least one of:
the one or more signals being received from the at least one TRP within the first subset of the plurality of TRPs; and
the one or more signals being transmitted to the at least one TRP within the first subset of the plurality of TRPs.

3. The method of claim 1, wherein the information indicating the selection of the first subset of the TRPs comprises information indicating a selection of at least one antenna on at least one TRP in the first subset of the TRPs.

4. The method of claim 1, wherein each of the TRPs has an antenna corresponding to an antenna of each other of the TRPs in the plurality of TRPs, wherein the information indicating the selection of the TRPs comprises information indicating that the corresponding antennas of each of the TRPs are selected.

5. The method of claim 1, wherein the first subset of TRPs comprises a single TRP, the single TRP comprising at least one of a transmitter and a receiver.

6. The method of claim 1, wherein the first subset of TRPs comprises two or more TRPs, each of the two or more TRPs comprising at least one of a transmitter and a receiver.

7. The method of claim 1, further comprising transmitting the one or more signals to the at least one TRP within the first subset of the plurality of TRPs.

8. The method of claim 1, further comprising receiving the one or more signals from the at least one TRP within the first subset of TRPs.

9. The method of claim 1, wherein the at least one radio channel measurement comprises at least one Reference Signal Received Power, RSRP, measurement.

10. The method of claim 1, wherein the at least one radio channel measurement comprises at least one Reference Signal Received Quality, RSRQ, measurement.

11. The method of claim 1, wherein the first subset of the TRPs includes only the TRPs having an associated radio channel measurement that is equal to or greater than a threshold value.

12. The method of claim 1, wherein the first subset of the TRPs includes only a single TRP having a best radio channel measurement.

13. The method of claim 1, wherein the first subset of the TRPs comprises a plurality of TRPs configured to be simultaneously active in the single cell.

14. The method of claim 1, wherein each TRP within the first subset of TRPs is configured to be simultaneously active in the single cell during a first transmission time interval, TTI.

15. The method of claim 1, wherein the first subset of the TRPs is associated with a plurality of wireless devices.

16. The method of claim 15, wherein each TRP within the first subset of the TRPs is associated with a respective one of the plurality of wireless devices.

17. The method of claim 15, wherein multiple TRPs within the first subset of the TRPs is associated with the wireless device.

18. The method of claim 17, wherein the at least one radio channel measurement is below a threshold value, and wherein the wireless device is associated with the multiple TRPs based on the at least one radio channel measurement being below the threshold value.

19. The method of claim 1, further comprising transmitting, to the network node, location information associated with the wireless device, and wherein the information indicating the selection of the first subset of TRPs is based on the location information associated with the wireless device.

20. The method of claim 1, further comprising transmitting information indicating an amount of data to be transmitted by the wireless device, and wherein the information indicating the selection of the first subset of TRPs is based on the information indicating the amount of data to be transmitted by the wireless device.

21. The method of claim 1, wherein the wireless device comprises a user equipment (UE).

22. A wireless device comprising processing circuitry configured to perform the method of claim 1.

23. A method performed by a network node, the method comprising:
obtaining a plurality of radio channel measurements, each of the plurality of radio channel measurements being associated with an associated one of a plurality of transmitting and receiving points, TRPs, the plurality of TRPs associated with a single cell; and based on the plurality of radio channel measurements, selecting a first subset of the TRPs for use in at least one of:
transmitting of one or more signals to one or more wireless devices; and
receiving one or more signals from one or more wireless devices, wherein the first subset of the TRPs is less than all of the plurality of TRPs.

24. The method of claim 23, wherein selecting the first subset of the TRPs comprises using at least one switch to enable the first subset of TRPs to at least one of:
transmit the one or more signals to the one or more wireless devices, and
receive the one or more signals from the one or more wireless devices.

25. The method of claim 23, further comprising:
based on the plurality of radio channel measurements, selecting a second subset of the TRPs for muting with respect to least one of:
the one or more signals to be transmitted to the one or more wireless devices, and
the one or more signals to be received from the one or more wireless devices, each TRP within the second subset not being within the first subset of the TRPs.

26. The method of claim 25, wherein selecting the second subset of the TRPs for muting comprises using at least one switch to disable or block the second subset of TRPs from at least one of:
transmitting the one or more signals to the one or more wireless devices, and
receiving the one or more signals from the one or more wireless devices.

27. The method of claim 23, wherein selecting the first subset of the TRPs comprises selecting at least one antenna on at least one TRP in the first subset of the TRPs.

28. The method of claim 23, further comprising receiving a plurality of uplink signals from the one or more wireless devices and non-coherently combining the plurality of uplink signals.

29. The method of claim 23, wherein each of the TRPs has multiple corresponding antennas, and wherein selecting the first subset of the TRPs comprises selecting the corresponding antennas on the TRPs for at least one of transmitting and receiving the one or more signals to the one or more wireless devices.

30. The method of claim 23, wherein the first subset of TRPs comprises a single TRP, the single TRP comprising at least one of a transmitter and a receiver.

31. The method of claim 23, wherein the first subset of TRPs comprises two or more TRPs, each of the two or more TRPs comprising at least one of a transmitter and a receiver.

32. The method of claim 23, wherein the plurality of radio channel measurements comprise a plurality of Reference Signal Received Power, RSRP, measurements.

33. The method of claim 23, wherein the plurality of radio channel measurements comprise a plurality of Reference Signal Received Quality, RSRQ, measurements.

34. The method of claim 23, wherein selecting the first subset of the TRPs comprises including in the first subset only the TRPs having an associated radio channel measurement that is equal to or greater than a threshold value.

35. The method of claim 23, wherein selecting the first subset of the TRPs comprises including in the first subset only a TRP having a best radio channel measurement.

36. The method of claim 23, wherein the first subset of the TRPs comprises a plurality of TRPs configured to be simultaneously active in the single cell, each of the plurality of TRPs being selected for at least one of:
transmission of the one or more signals to at least one of a plurality of wireless devices, and
reception of the one or more signals from at least one of a plurality of wireless devices.

37. The method of claim 23, wherein each TRP within the first subset of TRPs is configured to be simultaneously active in the single cell during a first transmission time interval (TTI).

38. The method of claim 23, further comprising associating the first subset of the TRPs with a plurality of wireless devices.

39. The method of claim 38, wherein each TRP within the first subset of the TRPs is associated with a respective one of the plurality of wireless devices.

40. The method of claim 38, wherein multiple TRPs within the first subset of the TRPs is associated with a particular one of the plurality of wireless devices.

41. The method of claim 40, wherein the particular one of the plurality of wireless devices is associated with multiple TRPs within the first subset of TRPs in response to determining that at least one radio channel measurement is below a threshold value.

42. The method of 38, further comprising obtaining location information associated with each one of the plurality of wireless devices, and wherein the association of the first subset of TRPs with the plurality of wireless devices is based on the location information associated with each one of the plurality of wireless devices.

43. The method of claim 38, further comprising obtaining information indicating an amount of data to be transmitted by each of the plurality of wireless devices, and wherein the association of the first subset of TRPs with the plurality of wireless devices is based on the information indicating the amount of data to be transmitted by each of the plurality of wireless devices.

44. The method of claim 23, wherein the network node is a base station.

45. A network node comprising processing circuitry configured to perform the method of claim 23.
